(19) United States
(12) Patent Application Publication
(10) Pub. No.: US 2025/0285215 A1
(43) Pub. Date: Sep. 11, 2025

(54) TECHNIQUES FOR GLOBAL STITCHING OF REGIONALLY DOWNSCALED CLIMATE MODELS

(71) Applicant: MCKINSEY & COMPANY, INC., New York, NY (US)

(72) Inventors: Riley Xavier Brady, Broomfield, CO (US); Jan Thérèse Maria Lenaerts, Boulder, CO (US); Kyle Richard Haver, Denver, CO (US); François Klein, Nivelles (BE); Alexis Smith Trittipo, New York, NY (US); Weixuan Xu, Bethesda, MD (US); Antara Banerjee, Denver, CO (US); Meredith Anne Fish, Arlington, VA (US); Zachary Scott Bruick, Fort Collins, CO (US); Yuting Chen, London (GB); Lindsay Slote Delevingne, Newton, MA (US); Faith Penny Groff, Fort Collins, CO (US); Varun Jayant Rajaram, Brooklyn, NY (US); Michael Dean Sierks, Silver Spring, MD (US)

(21) Appl. No.: 18/601,549

(22) Filed: Mar. 11, 2024

(51) Int. Cl. G06T 3/4038

(52) U.S. Cl. CPC G06T 3/4038

(57) ABSTRACT

Systems and methods for downscaled global model stitching are disclosed. An example system includes a memory storing instructions, including a stitching algorithm, and a processor interfacing with the memory. The instructions cause the system to receive a dataset comprising a plurality of domains that each have a plurality of data and share a boundary with another respective domain; and create an overlap region associated with a boundary between a pair of domains. The instructions further cause the system to determine, by executing the stitching algorithm, a weighting for each respective data point in the pair of domains based on a distance of the respective data point from a first boundary of the overlap region or a second boundary of the overlap region, create a stitched overlap region based on the weightings, and place the stitched overlap region along the boundary between the pair of domains.

### FIELD OF THE DISCLOSURE

The present disclosure generally relates to optimizing resolution of high data density models, such as global climate models, and more particularly, to techniques for downscaled global model stitching.

### BACKGROUND

Global climate modeling is an area of great interest, offering insights that benefit populations and industries worldwide. However, global climate modeling generally involves a substantial amount of data that can occupy, if not overburden, significant computing resources to achieve reasonable results. For example, conventional global climate models cannot be natively run at high spatial resolution (e.g., 10 km or less) at least due to computational expense (e.g., time and hardware limitations).

To alleviate these computational burdens, many conventional global climate models simulate the Earth's major components (e.g., ocean, land, and atmosphere) at coarse resolutions (e.g., ˜100-250 km) to more efficiently resolve large-scale interactions in the climate system. Of course, the climate system is spatially heterogeneous, such that climate conditions can vary substantially over distances much smaller than the resolution of the conventional models. Thus, these outputs are unreliable for informative regional climate risk analysis, as the coarse granularity of these conventional climate models results in an unrepresentative average of the conditions in large areas.

Conventionally, these coarse results may be downscaled to a higher resolution (e.g., 50 km or less) by training the model output on historical observations, in turn providing finer resolution inputs for climate impact studies or other uses. While all downscaling methods enable higher resolution model output, scientists must consider tradeoffs when selecting a downscaling method to use. Some methods apply downscaling over sub-continental sized domains using historical weather patterns (“regional downscaling”), while others apply downscaling at the individual coarse climate model grid cell level (“local downscaling”). The former method leads to downscaled results that are informed by consistent and coherent weather patterns at all scales, leading to high accuracy for highly variable weather patterns at regional scales, but cannot directly provide global results because weather patterns will vary across regions. The latter method leads to a global dataset out of the box, but neighboring grid cells are often informed by various blends of different historical weather patterns and localized statistical quantities, leading to potential inconsistencies from one location to the next. Climate impact studies conventionally require global datasets with weather/climate extremes preserved across scales and without sudden discontinuities over regional scales.

In an attempt to eliminate/minimize the discontinuities and provide global results, these conventional techniques typically utilize smoothing techniques. For example, some form of smoothing is generally required for regional downscaling methods to convert the regional dataset into a global dataset because each regional downscaling domain is informed by different weather patterns and geography (e.g., topography) than neighboring domain(s), resulting in large discontinuities between neighboring domains. Local downscaling methods conventionally use some form of spatial smoothing to remedy the discontinuities between neighboring grid cells. However, these spatial smoothing techniques frequently dampen extreme weather events and are characterized by reduced accuracy relative to regional downscaling methods. Accordingly, these conventional methods suffer from issues that reduce or eliminate their ability to provide meaningful results for use in, for example, climate impact studies.

Moreover, these conventional techniques also suffer from significant computational issues as a tradeoff for methodological simplicity. Namely, conventional blending techniques occupy large volumes of computing resources to produce massive datasets (e.g., ˜TB), but still result in substantial data loss due to the smoothing process. Executing these conventional techniques therefore necessarily results in a trade-off between efficiency and accuracy, neither of which is acceptably sacrificed in the climate assessment context.

Accordingly, there is a need for techniques for stitching regionally downscaled climate models into a global dataset that increases the accuracy of boundary data while preserving climate extremes and minimizing discontinuities at all spatial and temporal scales.

### SUMMARY

Generally, the techniques for downscaled global model stitching described herein enable accurate and computationally efficient stitching of boundaries between regions that avoids abrupt boundaries, and thereby creates a regionally/globally coherent dataset. In particular, the techniques described herein utilize geographic region datasets (referenced herein as “domains”) in combination with a stitching algorithm to seamlessly stitch the domains together at their respective boundaries. The techniques described herein build intentional overlap zones between neighboring domains, which include redundant (but differing) data points that can be leveraged for seamlessly blending data across domain boundaries.

To illustrate, an exemplary application of the present techniques includes downscaling climate data in 24 independent domains that largely represent the inhabited regions of the planet, and stitching those domains together to generate a seamless, global, high-resolution dataset. The stitching algorithm of the present disclosure may create/define an overlap region between the adjacent boundaries of each pairwise set of the independent regions that share a real boundary, and each overlap region may include geocoordinate points and associated data values (e.g., temperature, precipitation). Of course, the resulting overlap regions may be a product of two, three, four, and/or any other suitable number of domains. The stitching algorithm may then determine the Euclidian distance of each point from the respective domain boundaries when the overlap region is removed from all original domains to determine a weighting for each point value. The stitching algorithm may then apply the weightings for each point value to determine a stitched point value for each point of the set of points and may place the fully stitched overlap region between the original domains to generate a seamlessly stitched boundary between the original domains. In certain embodiments, each of these functions may be performed for all domains and their respective pairwise boundaries with adjacent domains in parallel.

As a result, the techniques of the present disclosure can alleviate many of the issues associated with conventional techniques. Namely, the techniques of the present disclosure may create seamless transitions between domains, retain all underlying climate extremes by eliminating extreme data (e.g., climate, weather, etc.) dampening and intense/disjointed borders, and do not overburden computing resources during the stitching process. For example, the techniques of the present disclosure may automatically identify/create overlaps between domains and process all domain overlap regions in parallel to produce TBs of data without dampening weather extremes, as experienced when using conventional techniques.

In accordance with the above, and with the disclosure herein, the present disclosure includes improvements in computer functionality or in improvements to other technologies at least because the disclosure describes that, e.g., a hosting server (e.g., central server), or otherwise computing device (e.g., a user computing device), is improved where the performance of the hosting server or computing device is enhanced by a stitching algorithm. This algorithm, executing on the hosting server or user computing device, can accurately and efficiently detect overlap regions between adjacent domain boundaries and simultaneously stitch each of these boundaries together in parallel, in a manner that reduces the required computational overhead relative to conventional techniques. That is, the present disclosure describes improvements in the functioning of the computer itself or “any other technology or technical field” because a hosting server or user computing device, is enhanced with a stitching algorithm configured to generate a coherent, seamless, and stitched dataset with greater accuracy than was previously achievable with conventional techniques and that also consumes fewer computing resources than conventional techniques. This improves over the prior art at least because existing systems lack such evaluative functionality and are generally unable to analyze accurately and efficiently, much less, stitch such domain boundaries together.

Further, the present disclosure includes improvements to other technologies or technical fields at least because the present disclosure describes or introduces improvements in the field of climate modeling. Namely, the stitching algorithm executing on the server or other computing devices (e.g., user computing device) improves the field of climate modeling by introducing the capability to stitch adjacent domains (e.g., containing climate data) together in a manner that was previously unachievable using conventional techniques. This improves over conventional techniques at least because such techniques lack the ability to stitch adjacent domains together in a seamless, coherent manner, and are otherwise simply incapable of generating accurate domain borders.

Moreover, the present disclosure includes effecting a transformation or reduction of a particular article to a different state or thing, e.g., transforming or reducing the domain border stitching from a non-optimal or error state (e.g., extreme data dampening, intense/disjointed borders, etc.) to an optimal state by utilizing a stitching algorithm to create a coherent, seamless, and stitched dataset.

Still further, the present disclosure includes specific features other than what is well-understood, routine, conventional activity in the field, or adding unconventional steps that demonstrate, in various embodiments, particular useful applications, e.g., creating, by executing the stitching algorithm, an overlap region associated with a respective boundary between a respective pair of domains that includes a first set of data points from a first respective domain of the respective pair of domains and a second set of data points from a second respective domain of the respective pair of domains; determining a weighting for each respective data point in the first set of data points and the second set of data points based on a distance of the respective data point from a first boundary of the overlap region or a second boundary of the overlap region; and/or creating a stitched overlap region based on the weighting for each respective data point in the first set of data points and the second set of data points, among others.

In some embodiments, the techniques described herein relate to a system for dataset stitching, the system including: a memory storing a set of computer-readable instructions including a stitching algorithm; and a processor interfacing with the memory, and configured to execute the set of computer-readable instructions to cause the system to: receive a dataset including a plurality of domains, each domain of the plurality of domains having a plurality of data points, and each domain of the plurality of domains sharing a boundary with another respective domain of the plurality of domains, create, by executing the stitching algorithm, an overlap region associated with a respective boundary between a respective pair of domains that includes a first set of data points from a first respective domain of the respective pair of domains and a second set of data points from a second respective domain of the respective pair of domains, determine a weighting for each respective data point in the first set of data points and the second set of data points based on a distance of the respective data point from a first boundary of the overlap region or a second boundary of the overlap region, create a stitched overlap region based on the weighting for each respective data point in the first set of data points and the second set of data points, and place the stitched overlap region along the respective boundary between the respective pair of domains.

In some embodiments, the techniques described herein relate to a system, wherein the first boundary of the overlap region is adjacent to the first respective domain, the second boundary of the overlap region is adjacent to the second respective domain, and determining the weighting for each respective data point, further includes: determining, for each respective data point in the first set of data points, a first distance from the first boundary; and determining, for each respective data point in the second set of data points, a second distance from the second boundary.

In some embodiments, the techniques described herein relate to a system, wherein determining the weighting for each respective data point, further includes: determining, for each respective data point in the first set of data points and the second set of data points, an inverse distance based on the distance of the respective data point from a first boundary of the overlap region or a second boundary of the overlap region; and calculating the weighting for each respective data point based on the inverse distance.

In some embodiments, the techniques described herein relate to a system, wherein the stitched overlap region includes a plurality of blended data points including a weighted combination of respective pairs of data points from the first set of data points and the second set of data points, and creating the stitched overlap region further includes: applying the weighting for each respective data point to a corresponding respective data point; and calculating the weighted combination of the respective pairs of data points from the first set of data points and the second set of data points to create the plurality of blended data points.

In some embodiments, the techniques described herein relate to a system, wherein the set of computer-readable instructions, when executed by the processor, further cause the system to: create, substantially in parallel by executing the stitching algorithm, a plurality of overlap regions associated with a plurality of respective boundaries between a plurality of respective pairs of domains; determine, substantially in parallel, a weighting for each respective data point in the plurality of overlap regions; create, substantially in parallel, a plurality of stitched overlap regions based on the weighting for each respective data point in the plurality of overlap regions; and place, substantially in parallel, the plurality of stitched overlap regions along the plurality of respective boundaries between the plurality of respective pairs of domains.

In some embodiments, the techniques described herein relate to a system, further including: a user interface, and wherein the set of computer-readable instructions, when executed by the processor, further cause the system to: cause the respective pair of domains and the stitched overlap region to be displayed on the user interface for viewing by a user.

In some embodiments, the techniques described herein relate to a system, wherein the dataset includes one or more of: (i) temperature data, (ii) wind speed data, (iii) humidity data, (iv) rainfall data, (v) radiation data, (vi) snowfall data, (vii) soil moisture data, or (viii) atmospheric pressure data.

In some embodiments, the techniques described herein relate to a system, wherein the plurality of domains includes twenty-four domains, and the set of computer-readable instructions, when executed by the processor, further cause the system to: create, by executing the stitching algorithm, an overlap region associated with a respective boundary among three or more domains that each includes a respective set of data points; determine a weighting for each data point in the respective set of data points of each of the three or more domains based on a distance from a respective boundary of the overlap region; create a stitched overlap region based on the weighting for each data point in the respective set of data points of each of the three or more domains; and place the stitched overlap region along the respective boundary among three or more domains.

In some embodiments, the techniques described herein relate to a method for dataset stitching, the method including: receiving, at one or more processors, a dataset including a plurality of domains, each domain of the plurality of domains having a plurality of data points, and each domain of the plurality of domains sharing a boundary with another respective domain of the plurality of domains; creating, by the one or more processors executing a stitching algorithm, an overlap region associated with a respective boundary between a respective pair of domains that includes a first set of data points from a first respective domain of the respective pair of domains and a second set of data points from a second respective domain of the respective pair of domains; determining, by the one or more processors, a weighting for each respective data point in the first set of data points and the second set of data points based on a distance of the respective data point from a first boundary of the overlap region or a second boundary of the overlap region; creating, by the one or more processors, a stitched overlap region based on the weighting for each respective data point in the first set of data points and the second set of data points; and placing, by the one or more processors, the stitched overlap region along the respective boundary between the respective pair of domains.

In some embodiments, the techniques described herein relate to a method, wherein the first boundary of the overlap region is adjacent to the first respective domain, the second boundary of the overlap region is adjacent to the second respective domain, and determining the weighting for each respective data point, further includes: determining, for each respective data point in the first set of data points, a first distance from the first boundary; and determining, for each respective data point in the second set of data points, a second distance from the second boundary.

In some embodiments, the techniques described herein relate to a method, wherein determining the weighting for each respective data point, further includes: determining, for each respective data point in the first set of data points and the second set of data points, an inverse distance based on the distance of the respective data point from a first boundary of the overlap region or a second boundary of the overlap region; and calculating, by the one or more processors, the weighting for each respective data point based on the inverse distance.

In some embodiments, the techniques described herein relate to a method, wherein the stitched overlap region includes a plurality of blended data points including a weighted combination of respective pairs of data points from the first set of data points and the second set of data points, and creating the stitched overlap region further includes: applying, by the one or more processors, the weighting for each respective data point to a corresponding respective data point; and calculating, by the one or more processors, the weighted combination of the respective pairs of data points from the first set of data points and the second set of data points to create the plurality of blended data points.

In some embodiments, the techniques described herein relate to a method, further including: creating, substantially in parallel by the one or more processors executing the stitching algorithm, a plurality of overlap regions associated with a plurality of respective boundaries between a plurality of respective pairs of domains; determining, substantially in parallel by the one or more processors, a weighting for each respective data point in the plurality of overlap regions; creating, substantially in parallel by the one or more processors, a plurality of stitched overlap regions based on the weighting for each respective data point in the plurality of overlap regions; and placing, substantially in parallel by the one or more processors, the plurality of stitched overlap regions along the plurality of respective boundaries between the plurality of respective pairs of domains.

In some embodiments, the techniques described herein relate to a method, further including: causing, by the one or more processors, the respective pair of domains and the stitched overlap region to be displayed on a user interface for viewing by a user.

In some embodiments, the techniques described herein relate to a method, wherein the dataset includes one or more of: (i) temperature data, (ii) wind speed data, (iii) humidity data, (iv) rainfall data, (v) radiation data, (vi) snowfall data, (vii) soil moisture data, or (viii) atmospheric pressure data.

In some embodiments, the techniques described herein relate to a non-transitory computer-readable storage medium having stored thereon a set of instructions, executable by at least one processor, for dataset stitching, the instructions including: instructions for receiving a dataset including a plurality of domains, each domain of the plurality of domains having a plurality of data points, and each domain of the plurality of domains sharing a boundary with another respective domain of the plurality of domains; instructions for creating, by executing a stitching algorithm, an overlap region associated with a respective boundary between a respective pair of domains that includes a first set of data points from a first respective domain of the respective pair of domains and a second set of data points from a second respective domain of the respective pair of domains; instructions for determining a weighting for each respective data point in the first set of data points and the second set of data points based on a distance of the respective data point from a first boundary of the overlap region or a second boundary of the overlap region; instructions for creating a stitched overlap region based on the weighting for each respective data point in the first set of data points and the second set of data points; and instructions for placing the stitched overlap region along the respective boundary between the respective pair of domains.

In some embodiments, the techniques described herein relate to a non-transitory computer-readable storage medium, wherein the first boundary of the overlap region is adjacent to the first respective domain, the second boundary of the overlap region is adjacent to the second respective domain, and determining the weighting for each respective data point, further includes: instructions for determining, for each respective data point in the first set of data points, a first distance from the first boundary; and instructions for determining, for each respective data point in the second set of data points, a second distance from the second boundary.

In some embodiments, the techniques described herein relate to a non-transitory computer-readable storage medium, wherein determining the weighting for each respective data point, further includes: instructions for determining, for each respective data point in the first set of data points and the second set of data points, an inverse distance based on the distance of the respective data point from a first boundary of the overlap region or a second boundary of the overlap region; and instructions for calculating the weighting for each respective data point based on the inverse distance.

In some embodiments, the techniques described herein relate to a non-transitory computer-readable storage medium, wherein the stitched overlap region includes a plurality of blended data points including a weighted combination of respective pairs of data points from the first set of data points and the second set of data points, and creating the stitched overlap region further includes: instructions for applying the weighting for each respective data point to a corresponding respective data point; and instructions for calculating the weighted combination of the respective pairs of data points from the first set of data points and the second set of data points to create the plurality of blended data points.

In some embodiments, the techniques described herein relate to a non-transitory computer-readable storage medium, wherein the set of instructions further include: instructions for creating, substantially in parallel by executing the stitching algorithm, a plurality of overlap regions associated with a plurality of respective boundaries between a plurality of respective pairs of domains; instructions for determining, substantially in parallel, a weighting for each respective data point in the plurality of overlap regions; instructions for creating, substantially in parallel, a plurality of stitched overlap regions based on the weighting for each respective data point in the plurality of overlap regions; and instructions for placing, substantially in parallel, the plurality of stitched overlap regions along the plurality of respective boundaries between the plurality of respective pairs of domains.

In some embodiments, the techniques described herein relate to a non-transitory computer-readable storage medium, wherein the set of instructions further include: instructions for causing the respective pair of domains and the stitched overlap region to be displayed on a user interface for viewing by a user.

Advantages will become more apparent to those of ordinary skill in the art from the following description of the preferred embodiments which have been shown and described by way of illustration. As will be realized, the present embodiments may be capable of other and different embodiments, and their details are capable of modification in various respects. Accordingly, the drawings and description are to be regarded as illustrative in nature and not as restrictive and/or limiting.

### BRIEF DESCRIPTION OF THE DRAWINGS

The Figures described below depict various aspects of the system and methods disclosed therein. It should be understood that each Figure depicts an embodiment of a particular aspect of the disclosed system and methods, and that each of the Figures is intended to accord with a possible embodiment thereof. Further, wherever possible, the following description refers to the reference numerals included in the following Figures, in which features depicted in multiple Figures are designated with consistent reference numerals.

There are shown in the drawings arrangements which are presently discussed, it being understood, however, that the present embodiments are not limited to the precise arrangements and instrumentalities shown, wherein:

FIG. 1 illustrates an example computing environment for dataset stitching, in accordance with various embodiments described herein.

FIGS. 2A-2E illustrate components of the example computing environment of FIG. 1 stitching datasets, in accordance with various embodiments described herein.

FIG. 3 illustrates an example method for dataset stitching, in accordance with various embodiments described herein.

The Figures depict preferred embodiments for purposes of illustration only. Alternative embodiments of the systems and methods illustrated herein may be employed without departing from the principles of the invention described herein.

### DETAILED DESCRIPTION OF THE INVENTION

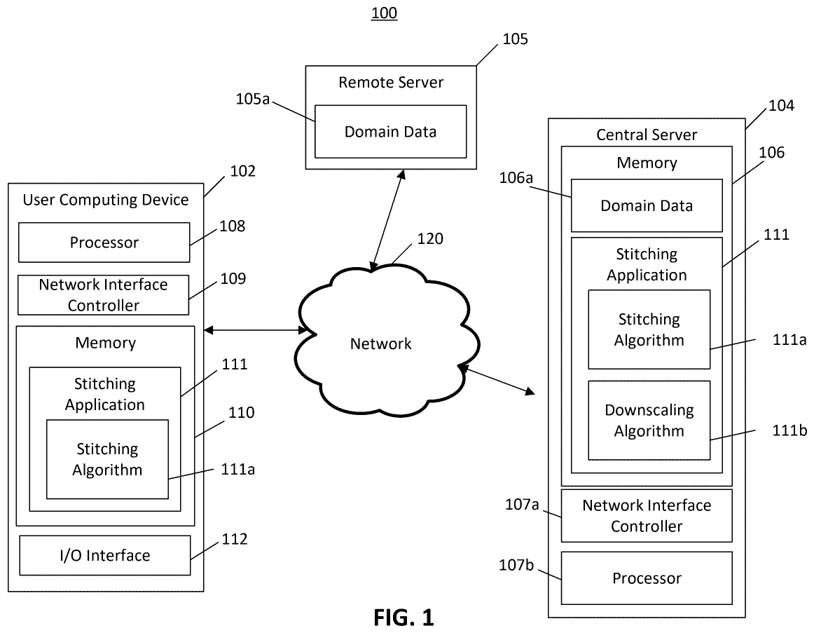

FIG. 1 depicts an example computing environment 100 for dataset stitching, in accordance with various embodiments described herein. The computing environment 100 includes a user computing device 102, a central server 104, a remote server 105, and a network 120. Some embodiments may include a plurality of user computing devices 102, a plurality of central servers 104, and/or a plurality of remote servers 105.

Generally, the central server 104 may include a memory 106, a network interface controller (NIC) 107a, and a processor 107b. The memory 106 may store domain data 106a, a stitching application 111, and a stitching algorithm 111a. As described herein, the stitching application 111 may be an executable application configured to receive domain data and generate a stitched set of domains through the stitching algorithm 111a and/or the downscaling algorithm 111b, which may each be included as part of the stitching application 111.

As referenced herein, each “domain” may correspond to a particular geographical region/area of the Earth. These domains may include downscaled data representative of particular conditions, events, topography, etc. in those domains at relatively high-resolutions (e.g., ˜10 km or less). For example, the domains of the present disclosure may comprise 24 independent geographical regions/areas that encompass most/all of the landmass on Earth, where each of the 24 domains includes data associated with the geographical region represented by the domain. More generally, there may be any suitable number of domains, each of which may be of any suitable size, such that the domains may include any suitable area. Further, the domains generally overlap, such that two or more domains include data corresponding to identical areas/locations.

Moreover, as referenced herein, the stitching algorithm 111a may generally be or include computer-executable instructions configured to perform, among other actions, weighting determinations and overlap region creation, stitching, and placement. However, it should be appreciated that, in some embodiments, some/all of these actions, and others, may be performed by other applications, modules, and/or otherwise components of the example computing environment 100 and/or other devices, apparatuses, and/or systems described herein. For example, overlap region creation may be performed by the processors 107b, 108 in accordance with executing the downscaling algorithm 111b stored in the memory 106, 110 prior to executing the stitching algorithm 111a. In this example, when the overlap regions have been created by execution of the downscaling algorithm 111b, the processors 107b, 108 may then proceed to execute the stitching algorithm 111a to proceed with weighting determination, overlap region stitching/placement, and/or any other suitable actions or combinations thereof.

In any event, the domain data 106a may be or include data indicating a history or projection of climate conditions, weather events, topography data, and/or any other suitable data for the domain. The data included in the domain data 106a may correspond to the entire domain and may include a plurality of data points corresponding to conditions/events/topography/etc. at distinct location/points within the domain. More specifically, the domain data may include data corresponding to distinct locations/points within the domain at any suitable granularity. For example, the domain data for a domain corresponding to Central America may include temperature data for the entirety of Central America that is collected at and/or otherwise representative of locations every 1-5 kilometers (km) across Central America and any encompassed bodies of water (e.g., Atlantic Ocean, Pacific Ocean).

In certain embodiments, the domain data 106a may be subdivided into one or more sub-sections that each correspond to a respective type of data (e.g., rainfall, thunderstorms, temperature, humidity, wind speed, radiation, snowfall, soil moisture, atmospheric pressure data, oceanographic data, land surface data, etc.) within the domain. More generally, the domain data 106a may be or include any suitable modeled variable with a corresponding observational grid and/or combinations thereof. Further, the domain data 106a may correspond to data describing any length of time (e.g., minutes, hours, days, weeks, months, years, etc.) and may include data extending back any suitable time in the past (e.g., weeks, months, years, etc.). For example, domain data representing a domain corresponding to Australia may include temperature data representing average temperatures across the entire Australia domain (e.g., including the encompassed Indian Ocean, Pacific Ocean, etc.) based on temperature data dating 50 years into the past. Continuing this example, the domain data may include twelve sub-sections corresponding to average temperatures across the entire Australia domain during each individual month based on the temperature data dating 50 years into the past.

The remote server 105 may also include domain data 105a. Generally speaking, the remote server 105 may be a free-source data repository that includes the domain data 105a for open access across the network 120. However, in certain aspects, the remote server 105 may be part of the central server 104 and/or the user computing device 102. Moreover, the domain data 105a included in the remote server 105 may generally include similar information as the domain data 106a included in the central server 104.

The user computing device 102 may include a processor 108, a network interface controller (NIC) 109, a memory 110, and an input/output (I/O) interface 112. Generally speaking, the user computing device 102 may be an individual computing device, a group of multiple computing devices, an individual server, a group (e.g., cluster) of multiple servers, and/or another suitable type of computing device or system (e.g., a collection of computing resources). The I/O interface 112 may include any suitable device or devices for receiving input, such as one or more microphone, one or more camera, a hardware keyboard, a hardware mouse, a capacitive touch screen, etc. The I/O interface 112 may also include any suitable device for conveying output, such as a hardware speaker, a computer monitor, a touch screen, etc. In some cases, the I/O interface 112 may be a single input/output device, such as a touch screen device that accepts user input and displays output.

In particular, a user may utilize the user computing device 102 to access the central server 104 and the remote server 105 in order to access the data and/or applications stored therein (e.g., 105a, 106a, 111). In this manner, the user computing device 102 may retrieve and/or otherwise access the data required to accurately and efficiently stitch datasets together.

Each of the modules stored in memory 110 implement specific functionality in order to accurately, efficiently, and seamlessly stitch datasets together. For example, the stitching application 111 includes computer-executable instructions for uploading and/or otherwise accessing datasets, facilitating users to select the relevant datasets, and executing the stitching algorithm 111a and/or the downscaling algorithm 111b to stitch the relevant datasets together to create a seamlessly stitched dataset, as described herein.

The user computing device 102 also includes a processor 108 and an NIC 109. The processor 108 may include any suitable number of processors and/or processor types, such as CPUs and one or more graphics processing units (GPUs). Generally, the processor 108 is configured to execute software instructions stored in memory 110, such as the stitching application 111, and more specifically, the stitching algorithm 111a and downscaling algorithm 111b.

More generally, the processor(s) 107b, 108 may be connected to the one or more memories 106, 110 via a computer bus responsible for transmitting electronic data, data packets, or otherwise electronic signals to and from the processor(s) 107b, 108 and the one or more memories 106, 110 in order to implement or perform the machine readable instructions, methods, processes, elements or limitations, as illustrated, depicted, or described for the various flowcharts, illustrations, diagrams, figures, and/or other disclosure herein.

The processor(s) 107b, 108 may interface with the one or more memories 106, 110 via the computer bus to execute an operating system (OS). The processor(s) 107b, 108 may also interface with the one or more memories 106, 110 via the computer bus to create, read, update, delete, or otherwise access or interact with the data stored in the one or more memories 106, 110. The data stored in the one or more memories 106, 110 may include all or part of any of the data or information described herein, including, for example, the stitching application 111, the stitching algorithm 111a, the downscaling algorithm 111b, and/or any other data stored in the one or more memories 106, 110. The memories 106, 110 may include one or more persistent memories (e.g., a hard drive/solid state memory) and stores one or more set of computer executable instructions/modules, including the stitching application 111, the stitching algorithm 111a, and the downscaling algorithm 111b.

In general, a computer program or computer based product, application, or code (e.g., the stitching application 111, the stitching algorithm 111a, the downscaling algorithm 111b, and/or other computing instructions described herein) may be stored on a computer usable storage medium, or tangible, non-transitory computer-readable medium (e.g., standard random access memory (RAM), an optical disc, a universal serial bus (USB) drive, or the like) having such computer-readable program code or computer instructions embodied therein, wherein the computer-readable program code or computer instructions may be installed on or otherwise adapted to be executed by the processor(s) 107b, 108 (e.g., working in connection with the data in the one or more memories 106, 110) to facilitate, implement, or perform the machine readable instructions, methods, processes, elements or limitations, as illustrated, depicted, or described for the various flowcharts, illustrations, diagrams, figures, and/or other disclosure herein. In this regard, the program code may be implemented in any desired program language, and may be implemented as machine code, assembly code, byte code, interpretable source code or the like (e.g., via Golang, Python, C, C++, C#, Objective-C, Java, Scala, ActionScript, JavaScript, HTML, CSS, XML, etc.).

As mentioned, the one or more memories 106, 110 may include one or more forms of non-transitory, volatile and/or non-volatile, fixed and/or removable memory, such as read-only memory (ROM), electronic programmable read-only memory (EPROM), random access memory (RAM), erasable electronic programmable read-only memory (EEPROM), and/or other hard drives, flash memory, MicroSD cards, and others. In certain aspects, the one or more memories 106, 110 may store an operating system (OS) (e.g., Microsoft Windows, Linux, Unix, etc.) capable of facilitating the functionalities, applications, methods, or other software as discussed herein.

The one or more memories 106, 110 may also store the stitching application 111, the stitching algorithm 111a, the downscaling algorithm 111b, as well as other data (not shown), including any of one or more application(s), one or more software component(s), and/or one or more application programming interfaces (APIs), which may be implemented to facilitate or perform the features, functions, or other disclosure described herein, such as any methods, processes, elements or limitations, as illustrated, depicted, or described for the various flowcharts, illustrations, diagrams, figures, and/or other disclosure herein. For example, at least some of the applications, software components, or APIs may be, include, or otherwise be part of the stitching application 111, the stitching algorithm 111a, and/or the downscaling algorithm 111b, where each may be configured to facilitate their various functionalities discussed herein. It should be appreciated that one or more other applications may be envisioned and that are executed by the processor(s) 107b, 108.

The NICs 107a, 109 may include any suitable network interface controller(s), such as wired/wireless controllers (e.g., Ethernet controllers), and facilitate bidirectional/multiplexed networking over the network 120 between the user computing device 102 and other components of the environment 100 (e.g., central server 104, the remote server 105, etc.). The NICs 107a, 109 may be configured to communicate (e.g., send and receive) data via one or more external/network port(s) to one or more networks or local terminals, such as a computer network and/or user computing devices (e.g., user computing device 102, central server 104), as described herein.

In some embodiments, the user computing device 102, central server 104, and/or the remote server 105 may include a client-server platform technology such as ASP.NET, Java J2EE, Ruby on Rails, Node.js, a web service or online API, responsive for receiving and responding to electronic requests. The user computing device 102, central server 104, and/or the remote server 105 may implement the client-server platform technology that may interact, via the computer bus, with the one or more memories 106, 110 (including the applications(s), component(s), API(s), data, etc. stored therein) to implement or perform the machine readable instructions, methods, processes, elements or limitations, as illustrated, depicted, or described for the various flowcharts, illustrations, diagrams, figures, and/or other disclosure herein.

According to some embodiments, the user computing device 102, central server 104, and/or the remote server 105 may include, or interact with, one or more transceivers (e.g., WWAN, WLAN, and/or WPAN transceivers) functioning in accordance with IEEE standards, 3GPP standards, or other standards, and that may be used in receipt and transmission of data via external/network ports connected to a computer network. The network 120 may be a single communication network or may include multiple communication networks of one or more types (e.g., one or more wired and/or wireless local area networks (LANs), and/or one or more wired and/or wireless wide area networks (WANs) such as the Internet). The network 120 may enable bidirectional communication between the central server 104, the user computing device 102, the remote server 105, and/or between multiple central servers 104, for example.

The user computing device 102, central server 104, and/or the remote server 105 may further include or implement an operator interface configured to present information to an administrator or operator and/or receive inputs from the administrator or operator. For example, an operator interface may provide a display screen (e.g., via user computing device 102). The user computing device 102, central server 104, and/or the remote server 105 may also provide I/O components (e.g., ports, capacitive or resistive touch sensitive input panels, keys, buttons, lights, LEDs), which may be directly accessible via or attached to the user computing device 102 (e.g., via I/O interface 112), central server 104, and/or the remote server 105 or may be indirectly accessible via or attached to an internal user computing device (e.g., 102). According to some embodiments, an administrator or operator may access the user computing device 102, central server 104, and/or the remote server 105 to review information (e.g., secure file access), make changes, input secure file share requests, and/or perform other functions.

As described above herein, in some embodiments, the user computing device 102, central server 104, the remote server 105, and/or any other components, devices, or system described herein may perform the functionalities as discussed herein as part of a “cloud” network or may otherwise communicate with other hardware or software components within the cloud to send, retrieve, or otherwise analyze data or information described herein. For example, the user computing device 102, the central server 104, and/or the remote server 105 may store pairs of domains, stitched overlap regions, and/or any other data in local storage (e.g., one or more memories 106, 110) and/or in a cloud storage service.

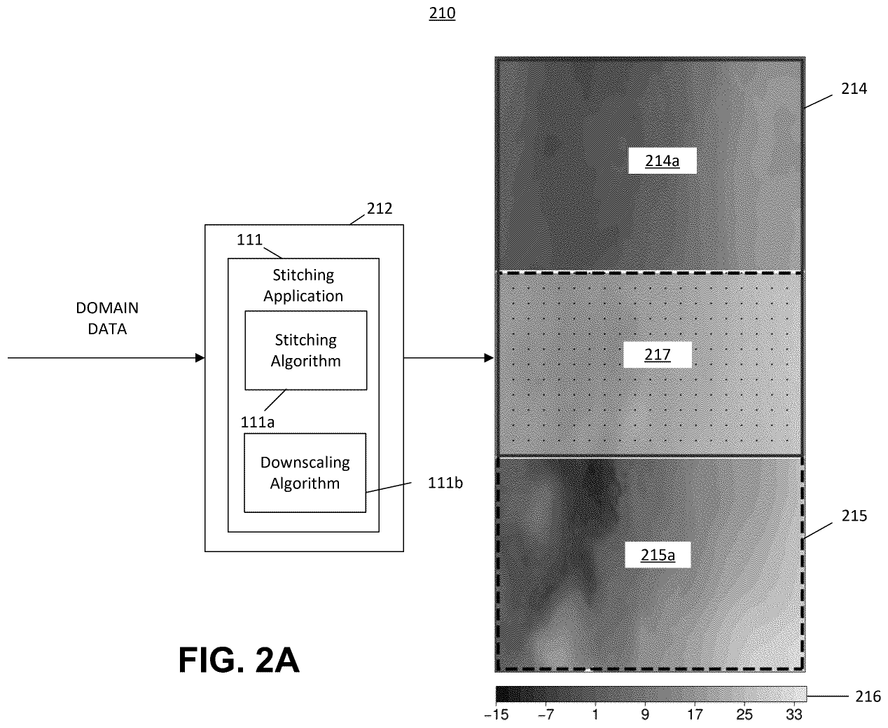

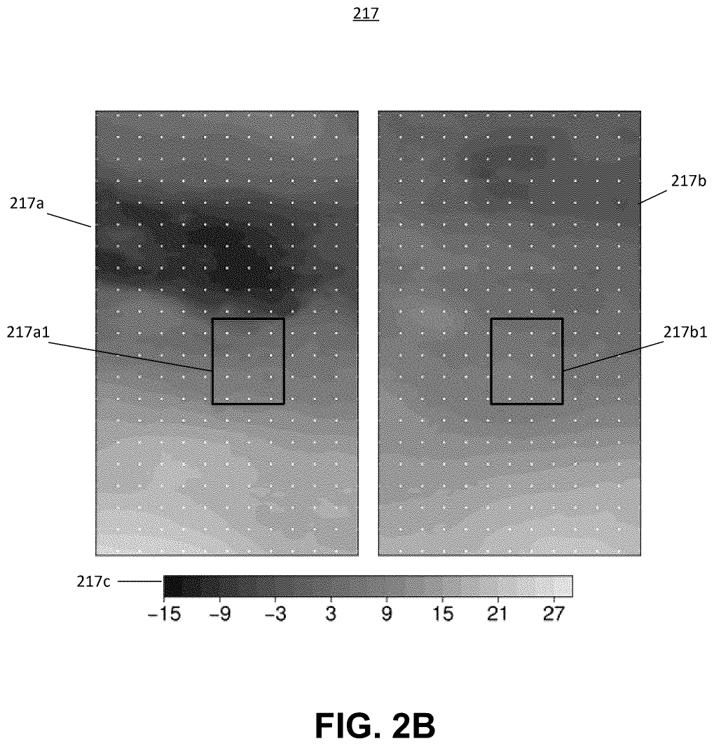

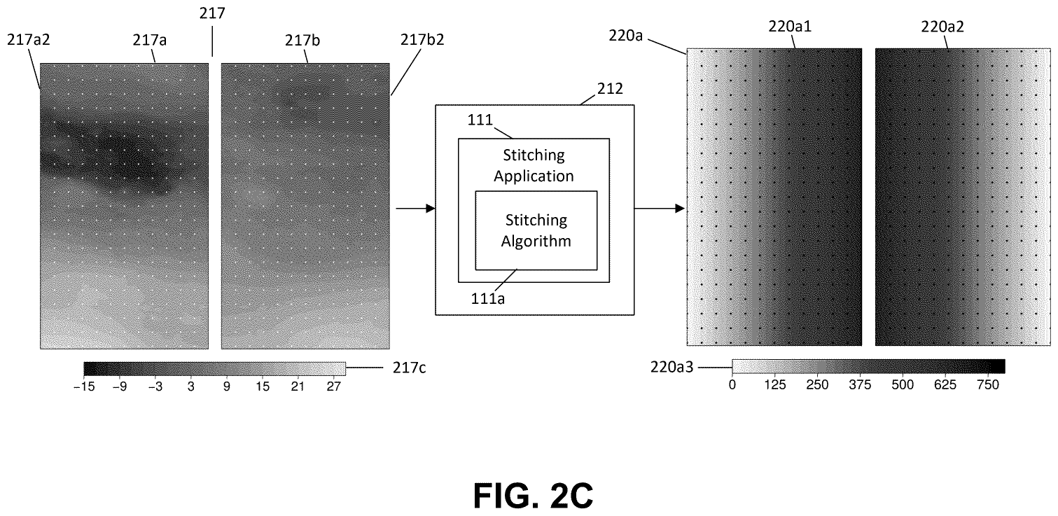

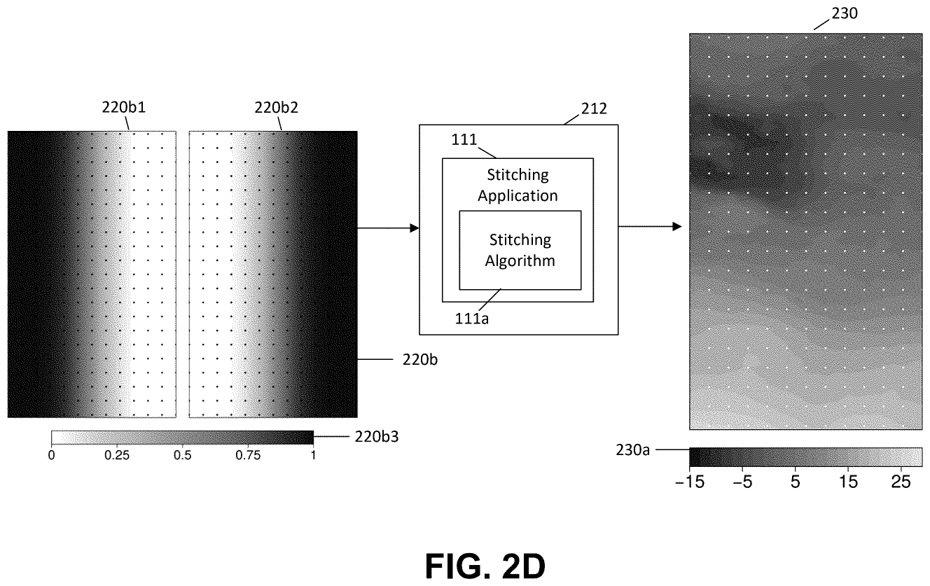

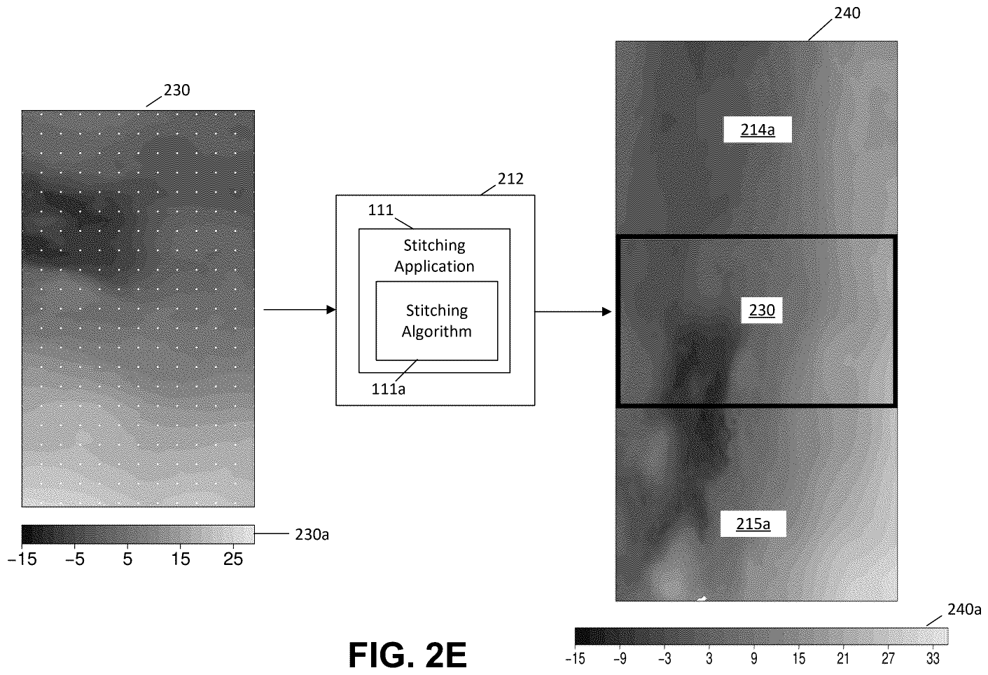

To provide a better understanding of the functionalities disclosed above regarding the stitching application 111, the stitching algorithm 111a, and the downscaling algorithm 111b, FIGS. 2A-2E illustrate example inputs and outputs of these components. Namely, FIG. 2A includes the stitching application 111, the stitching algorithm 111a, and/or the downscaling algorithm 111b (collectively referenced herein as a stitching module 212) receiving domain data as input and generating an overlap region 217.

As previously mentioned, the domain data indicated in FIG. 2A may be or include a dataset including a plurality of data points corresponding to multiple domains. These datasets may include temperature data, wind speed data, humidity data, rainfall data, radiation data, snowfall data, soil moisture data, atmospheric pressure data, and/or any other suitable data type associated with the domain. For example, the datasets represented in FIG. 2A may include temperature data, such that the patterns, gradients, and/or other graphical indications in the first domain 214 and the second domain 215 generally represent temperature values/variations across the first domain 214 and the second domain 215. The first domain 214 and/or the second domain 215 may also include any data type(s) and a corresponding legend 216 indicating a relative scale of the values contained therein (e.g., surface temperature in degrees Celsius).

Further, at least two of the domains represented in the domain data may share a boundary, such that the domain data of a first domain (e.g., Western Africa) may end at a first boundary that is shared with a second, adjacent domain (e.g., Eastern Africa) that includes additional domain data beyond the first boundary. Of course, any particular domain represented in the domain data may share more than one boundary with other adjacent domains. For example, the Amazon domain (corresponding to northern South America) may share a first boundary with the Southern America domain (corresponding to southern South America) and a second boundary with the Central America domain (corresponding to Central America). Further, any particular domain may share any suitable number of boundaries with any suitable number of domains.

In any event, when received as input at the stitching module 212, the downscaling algorithm 111b may, as part of and/or in addition to downscaling the domain data, determine an overlap region associated with respective boundaries between any number of overlapping domains. As illustrated in FIG. 2A, the domain data may include sets of data points associated with a first domain 214 (represented by the solid line box) and a second domain 215 (indicated by the dashed line box). The downscaling algorithm 111b may automatically determine how much of an overlap region 217 to create between the two domains 214, 215 at and/or near their shared boundary. In some embodiments, the downscaling algorithm 111b creates an overlap region by identifying regions between/among adjacent domains that overlap (e.g., have data corresponding to identical/similar geographical locations), and then designating these overlapping regions of the multiple adjacent domains as an overlap region.

In any event, the downscaling algorithm 111b may determine that the two domains 214, 215 require a larger or smaller overlap region, for example, based on the type of data (e.g., temperature data, wind speed data, humidity data, radiation data, snowfall data, soil moisture data, atmospheric pressure data) included as part of the datasets. Certain data types may experience less variation across adjacent domains, and may therefore require more/less of an overlap region for the stitching algorithm 111a to achieve a seamless stitch between the two domains. Thus, the downscaling algorithm 111b may generate/create the overlap region 217 based on these parameters while also downscaling the domain data. In certain embodiments, the downscaling algorithm 111b may create a standard overlap region with a predetermined width and/or predetermined volume of data.

Generally speaking, the overlap region 217 created by the downscaling algorithm 111b may include data points from both the first domain 214 and the second domain 215. These data points from the two domains 214, 215 may be aligned by the downscaling algorithm 111b to ensure that the overlap region 217 has two data points at each location (represented by the dots in the overlap region 217) within the overlap region 217. Consequently, when the downscaling algorithm 111b has created the overlap region 217 between the first domain 214 and the second domain 215, the two domains 214, 215 will each have a portion of their respective datasets included in the overlap region 217 and another portion 214a, 215a outside of the overlap region 217.

To describe the overlap region 217 more fully, FIG. 2B provides a detailed illustration of the overlap region 217 components. Namely, and as previously described, the overlap region 217 is comprised of sets of data points from multiple domains (e.g., first domain 214 and second domain 215). The overlap region 217 can therefore be decomposed into at least two portions 217a, 217b of identical size from the respective component domains. These two portions 217a, 217b may include data corresponding to identical or substantially similar locations that are going to be combined by the stitching algorithm 111a, as described herein. However, as a result of the downscaling performed by the downscaling algorithm 111b and/or other factors, these identical/similar locations may feature data differences, as illustrated by the subtle variations in patterns, gradients, and/or other graphical indications between the first portion 217a and the second portion 217b. In other words, the data value differences between the data points of the first portion 217a and the second portion 217b are due to the data points of the first portion 217a being adjusted by downscaling differently than the data points of the second portion 217b. The overlap region 217 may include any data type(s) and a corresponding legend 217c indicating a relative scale of the values contained therein for any/all of the domains represented therein (e.g., surface temperature in degrees Celsius).

Thus, it is likely that the values of the data points in the first portion 217a include at least some differences from the values of the data points in the second portion 217b. For example, consider the first sub-portion 217al and the second sub-portion 217b1. These two sub-portions 217a1, 217b1 may include data points that represent identical or substantially similar locations, and are utilized by the stitching algorithm 111a to create a stitched overlap region, as described herein. However, the data associated with the data points representing identical locations may differ (e.g., different temperature, wind speed, humidity, etc.) as a result of, for example, downscaling by the downscaling algorithm 111b based on being trained on different regional weather patterns and/or other factors. Accordingly, the first sub-portion 217al may include a plurality of data points (e.g., represented by the individual dots) that may include different or identical data values as each of the data points in the second sub-portion 217b1 corresponding to an identical or substantially similar location.

As an example, the first portion 217a may include a set of data points that were originally located in a Northern Europe domain near a shared boundary with a Central Europe domain, and the second portion 217b may include a set of data points that originally corresponded to the same/similar locations as the first portion 217a, but were included in the Central Europe domain. Thus, the data points in the first sub-portion 217al may represent data values (e.g., temperature values, humidity values, wind speed values, radiation values, snowfall values, soil moisture values, atmospheric pressure values, etc.) that have been downscaled in accordance with weather patterns associated with locations in the Northern Europe domain, and the data points in the second sub-portion 217b1 may represent data values that have been downscaled in accordance with weather patterns associated with locations in the Central Europe domain.

Regardless, when the downscaling algorithm 111b creates the overlap region 217, the stitching algorithm 111a may proceed to determine a weighting for each data point in the first set of data points (e.g., in the first portion 217a) and the second set of data points (e.g., in the second portion 217b). Practically speaking, the stitching algorithm 111a may detect any arbitrary number of overlap regions, as well as all of the domains contributing to each overlap region, calculate the inverse distance-based weighting function for those overlap regions, apply the weightings to the respective data points, and replace the original overlap regions with the calculated (i.e., weighted) results. More specifically, the stitching algorithm 111a may detect redundant/overlapping grid points between arbitrary domains.

In the examples illustrated herein, these overlapping grid points are represented in a rectangle over two domains, but it should be appreciated that these examples are for ease of discussion only. The overlap regions, and consequently, the overlapping grid points detected by the stitching algorithm 111a could represent three or more domains coming together. For example, four domains may share a “corner” type boundary and the stitching algorithm 111a may detect a square overlap zone and handle this square overlap zone separately from the surrounding 2-domain rectangular overlap zones.

In any event, FIG. 2C illustrates the stitching algorithm 111a determining distances for the overlap region 217, and more specifically, for data points in the respective portions 217a, 217b relative to a first boundary of the overlap region 217 and/or a second boundary of the overlap region 217.

As illustrated in FIG. 2C, the stitching algorithm 111a may analyze the overlap region 217 to determine distances (e.g., in km, miles, etc.) of each data point in the overlap region 217 from the boundaries of the overlap region 217 that are adjacent to the original domains. The stitching algorithm 111a may calculate distances of each point in the first portion 217a from a first boundary 217a2. The first boundary 217a2 may represent a boundary between the overlap region 217 and a remaining portion (e.g., 214a) of a domain (e.g., first domain 214) in which the first portion 217a data points were originally located. Similarly, the stitching algorithm 111a may calculate distances of each point in the second portion 217b from a second boundary 217b2. The second boundary 217b2 may represent a boundary between the overlap region 217 and a remaining portion (e.g., 215a) of a domain (e.g., second domain 215) in which the second portion 217b data points were originally located. In certain embodiments, the distances calculated by the stitching algorithm 111a may be or include a Euclidean distance of points within the first portion 217a and/or the second portion 217b from the first boundary 217a2 and/or the second boundary 217b2.

These distances are illustrated in FIG. 2C by the distance mapping 220a output by the stitching algorithm 111a. In particular, the patterns, gradients, and/or other graphical indications of the first distance mapping 220al may represent distances of the data points in the first portion 217a from the first boundary 217a2 of the overlap region 217, and the patterns, gradients, and/or other graphical indications of the second distance mapping 220a2 may represent distances of the data points in the second portion 217b from the second boundary 217b2 of the overlap region 217. The distance mapping 220a may generally include any suitable distances (e.g., Euclidean distance) and a corresponding legend 220a3 indicating a relative scale of the values contained therein (e.g., distance from domain boundary in kilometers (km)).

Moreover, the stitching algorithm 111a may determine, for each data point in the first portion 217a and the second portion 217b, an inverse distance based on the distances of the data points in the first portion 217a and/or the second portion 217b from the first boundary 217a2 and/or the second boundary 217b2 of the overlap region 217. The stitching algorithm 111a may utilize these inverse distances to determine weightings for each data point in the overlap region 217, as illustrated by the weighting mapping 220b of FIG. 2D, whereby the mapping 220b includes a first weighting mapping 220b1 and a second weighting mapping 220b2. The first weighting mapping 220b1 may include patterns, gradients, and/or other graphical indications corresponding to weightings of the data points in the first portion 217a from the first boundary 217a2 of the overlap region 217. The second weighting mapping 220b2 may include patterns, gradients, and/or other graphical indications corresponding to weightings of the data points in the second portion 217b from the second boundary 217b2 of the overlap region 217.

In any event, the stitching algorithm 111a may determine weightings for each data point in the overlap region 217 to ultimately create a stitched overlap region based on the weightings. Broadly speaking, the weighting value(s) illustrated in the weighting mapping 220b may be numerical value(s) corresponding to a degree of influence each data point will have in the final stitched value as part of the stitched overlap region, as discussed herein. More specifically, the weighting value(s) represented in the weighting mapping 220b may be determined by the stitching algorithm 111a in accordance with the following equation:

$${w}_{k} = \frac{\frac{1}{{dist}_{k}^{p}}}{{\sum }_{i = 1}^{N} ( \frac{1}{{dist}_{i}^{p}} )} , \qquad ( 1 )$$

where wₖ represents the grid of weighting values in the weighting mapping 220b to be applied to the data points associated with domain k in the overlap region 217. The particular domain k may be out of an arbitrary number of domains k=1, 2, . . . , N. In equation (1), distₖ is the distance of each point in the overlap region 217 to the boundary associated with domain k, and p is the exponent to which the inverse distance is raised, and which thereby dictates the relative influence of distance to the boundary for each data point. Further in equation (1), distᵢ is the distances of each data point in the overlap region 217 from the boundary associated with domain i, where i ranges from 1 to the total number of domains contributing to the overlap region 217, N. Thus, in cases where i=k, distᵢ and distₖ will be equal. In certain embodiments, the weightings represented by the weighting mapping 220b may range from 0 to 1, as illustrated by the legend 220b3 indicating the scale of weighting values applied for stitching associated with the weighting mapping 220b.

With these weightings for each data point, the stitching algorithm 111a may create a stitched overlap region 230. Generally speaking, the stitched overlap region 230 may include a plurality of data points that are each a blend of the data points from the domains (e.g., first domain 214, second domain 215) represented in the overlap region 217. In certain embodiments, the stitched overlap region 230 includes a plurality of blended data points comprising a weighted combination of respective pairs of data points from a first set of data points (e.g., data points in the first portion 217a) and a second set of data points (e.g., data points in the second portion 217b). In these embodiments, the stitching algorithm 111a may apply the weighting for each respective data point to a corresponding respective data point, and calculate the weighted combination of the respective pairs of data points from the first set of data points and the second set of data points to create the plurality of blended data points. The stitched overlap region 230 may include any data type(s) and a corresponding legend 230a indicating a relative scale of the values contained therein (e.g., surface temperature in degrees Celsius).

As an example, the stitching algorithm 111a may calculate the weighted combination of data points from the overlap region 217 in accordance with the following equation:

$$o = {w}_{1} {x}_{1} + ⋯ + {w}_{N} {x}_{N} , \qquad ( 2 )$$

where x₁ through x_{N} are data points from different contributing domains of the overlap region dependent on the number of domains included in the overlap region, and o is the weighted combination of the N data points based on the respective weightings w₁ through w_{N}, calculated using equation (1). For example, in the case where N=2, equation (2) will have two terms—an x₁ term and an x₂ term. In this example, the x₁ data point is from the first portion 217a and the x₂ data point is from the second portion 217b, respectively, and o is the weighted combination of the two data points based on the respective weightings w₁ and w₂. However, it should be understood that the stitching algorithm 111a may be configured to weight the data points in the overlap region 217 and/or generate a weighted combination of the data points in the overlap region 217 using any suitable weighting technique(s).

When the stitching algorithm 111a creates the stitched overlap region 230, the stitching algorithm 111a may proceed to place the stitched overlap region 230 along the original boundary between the domains (e.g., first domain 214, second domain 215) represented in the stitched overlap region 230, as represented in FIG. 2E. As illustrated in FIG. 2E, the stitching algorithm 111a may place the stitched overlap region 230 in an identical or substantially similar location as the overlap region 217. In this manner, the stitching algorithm 111a may create a stitched domain 240 that includes seamless transitions between the original domain portions (e.g., 214a, 215a) and the stitched overlap region 230. The stitched domain 240 may include any data type(s) and a corresponding legend 240a indicating a relative scale of the values contained therein (e.g., surface temperature in degrees Celsius).

As part of this stitched domain 240 creation, the stitching algorithm 111a may output the stitched domain 240 and/or just the stitched overlap region 230 for display to a user. Namely, the stitching algorithm 111a may include and/or cause the processor(s) (e.g., processor(s) 107b, 108) to generate a control instruction that causes a user interface (e.g., part of I/O interface 112) to display the stitched domain 240 and/or just the stitched overlap region 230 to a user. Moreover, these instructions may also include instructions that cause the user interface to display a plurality of these stitched domains and/or just stitched overlap regions to a user simultaneously. For example, the stitching algorithm 111a may include instructions that cause the user interface to display a stitched domain representing the Western and Eastern Africa domains, and/or to display stitched domains representing Southern, Western, and Eastern Africa and Central Europe simultaneously. Thus, it should be appreciated that any suitable number of stitched domains and/or stitched overlap regions may be simultaneously displayed to a user at any given time. In some embodiments, the stitching algorithm 111a may retrieve a global stitched dataset from memory (e.g., memory 106, 110) for display to the user, and the processors 107b and/or 108 may apply certain postprocessing steps/actions to the global stitched dataset before displaying and/or otherwise causing the global stitched dataset to be displayed to the user.

In certain embodiments, the stitching algorithm 111a may include instructions that cause the processor(s) (e.g., processor(s) 107b, 108) to perform each of the above-described actions in reference to FIGS. 2A-2E in parallel, and/or substantially in parallel, for some/all of the available domains. For example, the stitching algorithm 111a may instruct the processors to create, substantially in parallel, a plurality of overlap regions associated with a plurality of respective boundaries between a plurality of respective pairs of domains; determine, substantially in parallel, a weighting for each respective data point in the plurality of overlap regions; create, substantially in parallel, a plurality of stitched overlap regions based on the weighting for each respective data point in the plurality of overlap regions; and/or place, substantially in parallel, the plurality of stitched overlap regions along the plurality of respective boundaries between the plurality of respective pairs of domains. In this manner, the stitching algorithm 111a may reduce, minimize, and/or otherwise conserve computing resources at least by reducing the time required for the processors to perform the dataset stitching actions described herein for all available domains.

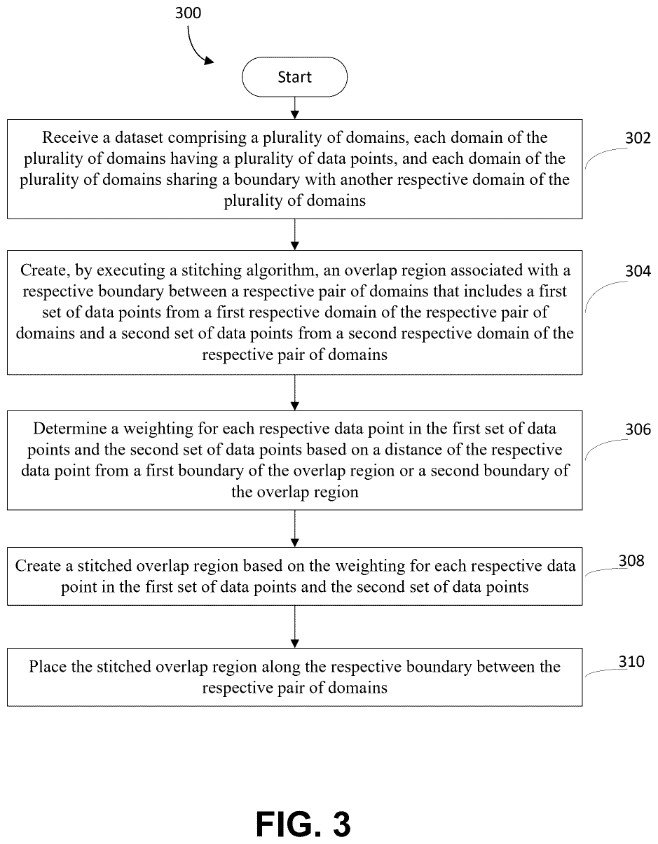

FIG. 3 illustrates an example method 300 for stitching datasets, in accordance with various embodiments described herein. At least portions of the method 300 may be performed by one or more processors (e.g., processor(s) 107b, 108, 202) utilizing the embodiments of the user computing device 102, the central server 104, and/or the remote server 105 of FIG. 1, for example, or by other suitable modules or systems. In embodiments, the method 300 may include additional or alternate steps other than those described herein.

At block 302, the example method 300 includes receiving a dataset comprising a plurality of domains. Each domain of the plurality of domains may have a plurality of data points, and each domain of the plurality of domains sharing a boundary with another respective domain of the plurality of domains. At block 304, the example method 300 includes creating, by executing a stitching algorithm, an overlap region associated with a respective boundary between a respective pair of domains that includes a first set of data points from a first respective domain of the respective pair of domains and a second set of data points from a second respective domain of the respective pair of domains.

At block 306, the example method 300 includes determining a weighting for each respective data point in the first set of data points and the second set of data points based on a distance of the respective data point from a first boundary of the overlap region or a second boundary of the overlap region. At block 308, the example method 300 includes creating a stitched overlap region based on the weighting for each respective data point in the first set of data points and the second set of data points. At block 310, the example method 300 includes placing the stitched overlap region along the respective boundary between the respective pair of domains.

In some embodiments, the first boundary of the overlap region is adjacent to the first respective domain, the second boundary of the overlap region is adjacent to the second respective domain, and determining the weighting for each respective data point, further includes determining, for each respective data point in the first set of data points, a first distance from the first boundary; and determining, for each respective data point in the second set of data points, a second distance from the second boundary.

In some embodiments, determining the weighting for each respective data point, further includes determining, for each respective data point in the first set of data points and the second set of data points, an inverse distance based on the distance of the respective data point from a first boundary of the overlap region or a second boundary of the overlap region; and calculating, by the one or more processors, the weighting for each respective data point based on the inverse distance.

In some embodiments, the stitched overlap region includes a plurality of blended data points including a weighted combination of respective pairs of data points from the first set of data points and the second set of data points, and creating the stitched overlap region further includes: applying, by the one or more processors, the weighting for each respective data point to a corresponding respective data point; and calculating, by the one or more processors, the weighted combination of the respective pairs of data points from the first set of data points and the second set of data points to create the plurality of blended data points.

In some embodiments, the example method 300 further includes creating, substantially in parallel by the one or more processors executing the stitching algorithm, a plurality of overlap regions associated with a plurality of respective boundaries between a plurality of respective pairs of domains; determining, substantially in parallel by the one or more processors, a weighting for each respective data point in the plurality of overlap regions; creating, substantially in parallel by the one or more processors, a plurality of stitched overlap regions based on the weighting for each respective data point in the plurality of overlap regions; and placing, substantially in parallel by the one or more processors, the plurality of stitched overlap regions along the plurality of respective boundaries between the plurality of respective pairs of domains.

In some embodiments, the example method 300 further includes causing the respective pair of domains and the stitched overlap region to be displayed on a user interface for viewing by a user.

In some embodiments, the dataset includes one or more of: (i) temperature data, (ii) wind speed data, (iii) humidity data, (iv) rainfall data, (v) radiation data, (vi) snowfall data, (vii) soil moisture data, (viii) atmospheric pressure data, and/or any other suitable data or combinations thereof.

In certain embodiments, the plurality of domains includes twenty-four domains, and the example method 300 further includes: creating, by executing the stitching algorithm, an overlap region associated with a respective boundary among three or more domains that each includes a respective set of data points; determining a weighting for each data point in the respective set of data points of each of the three or more domains based on a distance from a respective boundary of the overlap region; creating a stitched overlap region based on the weighting for each data point in the respective set of data points of each of the three or more domains; and placing the stitched overlap region along the respective boundary among three or more domains.

Of course, it should be appreciated that the plurality of domains described herein may include any suitable number of domains (e.g., 10, 24, 50, 100, 1000, etc.), and the stitching algorithm described herein may create an overlap region along a boundary among any suitable number of such domains (e.g., 2, 3, 4, . . . , n). Further, while referenced and illustrated herein primarily as rectangular domains, it should be appreciated that the domains may have any suitable configuration/shape, size, and/or otherwise dimensions.

### ADDITIONAL CONSIDERATIONS

Although the disclosure herein sets forth a detailed description of numerous different embodiments, it should be understood that the legal scope of the description is defined by the words of the claims set forth at the end of this patent and equivalents. The detailed description is to be construed as exemplary only and does not describe every possible embodiment since describing every possible embodiment would be impractical. Numerous alternative embodiments may be implemented, using either current technology or technology developed after the filing date of this patent, which would still fall within the scope of the claims.

The following additional considerations apply to the foregoing discussion. Throughout this specification, plural instances may implement components, operations, or structures described as a single instance. Although user operations of one or more methods are illustrated and described as separate operations, one or more of the user operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

Additionally, certain embodiments are described herein as including logic or a number of routines, subroutines, applications, or instructions. These may constitute either software (e.g., code embodied on a machine-readable medium or in a transmission signal) or hardware. In hardware, the routines, etc., are tangible units capable of performing certain operations and may be configured or arranged in a certain manner. In example embodiments, one or more computer systems (e.g., a standalone, client or server computer system) or one or more hardware modules of a computer system (e.g., a processor or a group of processors) may be configured by software (e.g., an application or application portion) as a hardware module that operates to perform certain operations as described herein.

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may, in some example embodiments, comprise processor-implemented modules.

Similarly, the methods or routines described herein may be at least partially processor-implemented. For example, at least some of the operations of a method may be performed by one or more processors or processor-implemented hardware modules. The performance of certain of the operations may be distributed among the one or more processors, not only residing within a single machine, but deployed across a number of machines. In some example embodiments, the processor or processors may be located in a single location, while in other embodiments the processors may be distributed across a number of locations.

The performance of certain of the operations may be distributed among the one or more processors, not only residing within a single machine, but deployed across a number of machines. In some example embodiments, the one or more processors or processor-implemented modules may be located in a single geographic location (e.g., within a home environment, an office environment, or a server farm). In other embodiments, the one or more processors or processor-implemented modules may be distributed across a number of geographic locations.

This detailed description is to be construed as exemplary only and does not describe every possible embodiment, as describing every possible embodiment would be impractical, if not impossible. A person of ordinary skill in the art may implement numerous alternate embodiments, using either current technology or technology developed after the filing date of this application.

Those of ordinary skill in the art will recognize that a wide variety of modifications, alterations, and combinations can be made with respect to the above described embodiments without departing from the scope of the invention, and that such modifications, alterations, and combinations are to be viewed as being within the ambit of the inventive concept.

The patent claims at the end of this patent application are not intended to be construed under 35 U.S.C. § 112(f) unless traditional means-plus-function language is expressly recited, such as “means for” or “step for” language being explicitly recited in the claim(s). The systems and methods described herein are directed to an improvement to computer functionality, and improve the functioning of conventional computers.

The dimensions and values disclosed herein are not to be understood as being strictly limited to the exact numerical values recited. Instead, unless otherwise specified, each such dimension is intended to mean both the recited value and a functionally equivalent range surrounding that value. For example, a dimension disclosed as “40 mm” is intended to mean “about 40 mm.”

Every document cited herein, including any cross referenced or related patent or application and any patent application or patent to which this application claims priority or benefit thereof, is hereby incorporated herein by reference in its entirety unless expressly excluded or otherwise limited. The citation of any document is not an admission that it is prior art with respect to any invention disclosed or claimed herein or that it alone, or in any combination with any other reference or references, teaches, suggests or discloses any such invention. Further, to the extent that any meaning or definition of a term in this document conflicts with any meaning or definition of the same term in a document incorporated by reference, the meaning or definition assigned to that term in this document shall govern.

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

What is claimed is:

1. A system for dataset stitching, the system comprising:
a memory storing a set of computer-readable instructions including a stitching algorithm; and
a processor interfacing with the memory, and configured to execute the set of computer-readable instructions to cause the system to:
receive a dataset comprising a plurality of domains, each domain of the plurality of domains having a plurality of data points, and each domain of the plurality of domains sharing a boundary with another respective domain of the plurality of domains,
create an overlap region associated with a respective boundary between a respective pair of domains that includes a first set of data points from a first respective domain of the respective pair of domains and a second set of data points from a second respective domain of the respective pair of domains,
determine, by executing the stitching algorithm, a weighting for each respective data point in the first set of data points and the second set of data points based on a distance of the respective data point from a first boundary of the overlap region or a second boundary of the overlap region,
create a stitched overlap region based on the weighting for each respective data point in the first set of data points and the second set of data points, and
place the stitched overlap region along the respective boundary between the respective pair of domains.

2. The system of claim 1, wherein the first boundary of the overlap region is adjacent to the first respective domain, the second boundary of the overlap region is adjacent to the second respective domain, and determining the weighting for each respective data point, further comprises:
determining, for each respective data point in the first set of data points, a first distance from the first boundary; and
determining, for each respective data point in the second set of data points, a second distance from the second boundary.

3. The system of claim 1, wherein determining the weighting for each respective data point, further comprises:
determining, for each respective data point in the first set of data points and the second set of data points, an inverse distance based on the distance of the respective data point from a first boundary of the overlap region or a second boundary of the overlap region; and
calculating the weighting for each respective data point based on the inverse distance.

4. The system of claim 1, wherein the stitched overlap region includes a plurality of blended data points comprising a weighted combination of respective pairs of data points from the first set of data points and the second set of data points, and creating the stitched overlap region further comprises:
applying the weighting for each respective data point to a corresponding respective data point; and
calculating the weighted combination of the respective pairs of data points from the first set of data points and the second set of data points to create the plurality of blended data points.

5. The system of claim 1, wherein the set of computer-readable instructions, when executed by the processor, further cause the system to:
create, substantially in parallel, a plurality of overlap regions associated with a plurality of respective boundaries between a plurality of respective pairs of domains;
determine, substantially in parallel by executing the stitching algorithm, a weighting for each respective data point in the plurality of overlap regions;
create, substantially in parallel, a plurality of stitched overlap regions based on the weighting for each respective data point in the plurality of overlap regions; and
place, substantially in parallel, the plurality of stitched overlap regions along the plurality of respective boundaries between the plurality of respective pairs of domains.

6. The system of claim 1, further comprising:
a user interface, and
wherein the set of computer-readable instructions, when executed by the processor, further cause the system to:
cause the respective pair of domains and the stitched overlap region to be displayed on the user interface for viewing by a user, and
store the respective pair of domains and the stitched overlap region in the memory.

7. The system of claim 1, wherein the dataset comprises one or more of: (i) temperature data, (ii) wind speed data, (iii) humidity data, (iv) rainfall data, (v) radiation data, (vi) snowfall data, (vii) soil moisture data, or (viii) atmospheric pressure data.

8. The system of claim 1, wherein the plurality of domains includes twenty-four domains, and the set of computer-readable instructions, when executed by the processor, further cause the system to:
create an overlap region associated with a respective boundary among three or more domains that each includes a respective set of data points;
determine, by executing the stitching algorithm, a weighting for each data point in the respective set of data points of each of the three or more domains based on a distance from a respective boundary of the overlap region;
create a stitched overlap region based on the weighting for each data point in the respective set of data points of each of the three or more domains; and
place the stitched overlap region along the respective boundary among three or more domains.

9. A method for dataset stitching, the method comprising:
receiving, at one or more processors, a dataset comprising a plurality of domains, each domain of the plurality of domains having a plurality of data points, and each domain of the plurality of domains sharing a boundary with another respective domain of the plurality of domains;
creating, by the one or more processors, an overlap region associated with a respective boundary between a respective pair of domains that includes a first set of data points from a first respective domain of the respective pair of domains and a second set of data points from a second respective domain of the respective pair of domains;
determining, by the one or more processors executing a stitching algorithm, a weighting for each respective data point in the first set of data points and the second set of data points based on a distance of the respective data point from a first boundary of the overlap region or a second boundary of the overlap region;
creating, by the one or more processors, a stitched overlap region based on the weighting for each respective data point in the first set of data points and the second set of data points; and
placing, by the one or more processors, the stitched overlap region along the respective boundary between the respective pair of domains.

10. The method of claim 9, wherein the first boundary of the overlap region is adjacent to the first respective domain, the second boundary of the overlap region is adjacent to the second respective domain, and determining the weighting for each respective data point, further comprises:
determining, for each respective data point in the first set of data points, a first distance from the first boundary; and
determining, for each respective data point in the second set of data points, a second distance from the second boundary.

11. The method of claim 9, wherein determining the weighting for each respective data point, further comprises:
determining, for each respective data point in the first set of data points and the second set of data points, an inverse distance based on the distance of the respective data point from a first boundary of the overlap region or a second boundary of the overlap region; and
calculating, by the one or more processors, the weighting for each respective data point based on the inverse distance.

12. The method of claim 9, wherein the stitched overlap region includes a plurality of blended data points comprising a weighted combination of respective pairs of data points from the first set of data points and the second set of data points, and creating the stitched overlap region further comprises:
applying, by the one or more processors, the weighting for each respective data point to a corresponding respective data point; and
calculating, by the one or more processors, the weighted combination of the respective pairs of data points from the first set of data points and the second set of data points to create the plurality of blended data points.

13. The method of claim 9, further comprising:
creating, substantially in parallel by the one or more processors, a plurality of overlap regions associated with a plurality of respective boundaries between a plurality of respective pairs of domains;
determining, substantially in parallel by the one or more processors executing the stitching algorithm, a weighting for each respective data point in the plurality of overlap regions;
creating, substantially in parallel by the one or more processors, a plurality of stitched overlap regions based on the weighting for each respective data point in the plurality of overlap regions; and
placing, substantially in parallel by the one or more processors, the plurality of stitched overlap regions along the plurality of respective boundaries between the plurality of respective pairs of domains.

14. The method of claim 9, further comprising:
causing, by the one or more processors, the respective pair of domains and the stitched overlap region to be displayed on a user interface for viewing by a user.

15. The method of claim 9, wherein the dataset comprises one or more of: (i) temperature data, (ii) wind speed data, (iii) humidity data, (iv) rainfall data, (v) radiation data, (vi) snowfall data, (vii) soil moisture data, or (viii) atmospheric pressure data.

16. A non-transitory computer-readable storage medium having stored thereon a set of instructions, executable by at least one processor, for dataset stitching, the instructions comprising:
instructions for receiving a dataset comprising a plurality of domains, each domain of the plurality of domains having a plurality of data points, and each domain of the plurality of domains sharing a boundary with another respective domain of the plurality of domains;
instructions for creating an overlap region associated with a respective boundary between a respective pair of domains that includes a first set of data points from a first respective domain of the respective pair of domains and a second set of data points from a second respective domain of the respective pair of domains;
instructions for determining, by executing a stitching algorithm, a weighting for each respective data point in the first set of data points and the second set of data points based on a distance of the respective data point from a first boundary of the overlap region or a second boundary of the overlap region;
instructions for creating a stitched overlap region based on the weighting for each respective data point in the first set of data points and the second set of data points; and
instructions for placing the stitched overlap region along the respective boundary between the respective pair of domains.

17. The non-transitory computer-readable storage medium of claim 16, wherein the first boundary of the overlap region is adjacent to the first respective domain, the second boundary of the overlap region is adjacent to the second respective domain, and determining the weighting for each respective data point, further comprises:
instructions for determining, for each respective data point in the first set of data points, a first distance from the first boundary; and
instructions for determining, for each respective data point in the second set of data points, a second distance from the second boundary.

18. The non-transitory computer-readable storage medium of claim 16, wherein determining the weighting for each respective data point, further comprises:
instructions for determining, for each respective data point in the first set of data points and the second set of data points, an inverse distance based on the distance of the respective data point from a first boundary of the overlap region or a second boundary of the overlap region; and
instructions for calculating the weighting for each respective data point based on the inverse distance.

19. The non-transitory computer-readable storage medium of claim 16, wherein the stitched overlap region includes a plurality of blended data points comprising a weighted combination of respective pairs of data points from the first set of data points and the second set of data points, and creating the stitched overlap region further comprises:
instructions for applying the weighting for each respective data point to a corresponding respective data point; and
instructions for calculating the weighted combination of the respective pairs of data points from the first set of data points and the second set of data points to create the plurality of blended data points.

20. The non-transitory computer-readable storage medium of claim 16, wherein the set of instructions further comprise:
instructions for creating, substantially in parallel, a plurality of overlap regions associated with a plurality of respective boundaries between a plurality of respective pairs of domains;
instructions for determining, substantially in parallel by executing the stitching algorithm, a weighting for each respective data point in the plurality of overlap regions;
instructions for creating, substantially in parallel, a plurality of stitched overlap regions based on the weighting for each respective data point in the plurality of overlap regions; and
instructions for placing, substantially in parallel, the plurality of stitched overlap regions along the plurality of respective boundaries between the plurality of respective pairs of domains.
